(19) United States
(12) Patent Application Publication
(10) Pub. No.: US 2016/0185457 A1
(43) Pub. Date: Jun. 30, 2016

(54) DEVICE FOR REMOVING DEBRIS FROM AN AERODYNAMIC STRUCTURE

(71) Applicant: Airbus Operations Limited, Bristol (GB)

(72) Inventors: Chetan Korya, Bristol (GB); Andrew McVey, Bristol (GB)

(21) Appl. No.: 14/983,088

(22) Filed: Dec. 29, 2015

(30) Foreign Application Priority Data
Dec. 29, 2014 (GB) 1423307.6

(51) Int. Cl. B64D 15/00

(52) U.S. Cl. CPC B64D 15/00

(57) ABSTRACT

A device for removing debris, such as insects and ice, from an aerodynamic structure of an aircraft and in which the aerodynamic structure has upper and lower surfaces separated by a leading edge extending along the length of the aerodynamic structure. The device includes a spine positionable so as to extend between the upper and lower surfaces over the leading edge of the aerodynamic structure, a scraping edge carried by the spine facing a direction that extends along the length, and a drive mechanism configured to move the spine in the direction so that the scraping edge scrapes debris from along the length of the aerodynamic structure. The spine is configured to bias the scraping edge against the aerodynamic structure.

### RELATED APPLICATION

This application claims priority to United Kingdom patent application 1423307.6 filed Dec. 29, 2014, the entirety of which is incorporated by reference.

### TECHNICAL FIELD

The present invention relates to a device for removing debris from an aerodynamic structure and to an aerodynamic structure incorporating the device of the invention.

### BACKGROUND

In the field of aeronautics it is known that laminar flow wing designs require an uninterrupted and undisturbed air flow over them in order to function properly. However, during certain phase of flight the surfaces of aerodynamic structures such as wings, can become contaminated with debris.

During landing and take-off insects may accumulate on a leading edge of lifting surfaces and, during cruise, ice can form on or behind the leading edge.

Organic build up and ice formation reduces the efficiency of an aircraft. It is therefore desirable to ensure that aerodynamic surfaces of an aircraft are kept free of such debris.

It is known to provide large transport passenger aircraft with ice protection systems to prevent ice buildup by making use of heating elements. However, such ice protection systems are located within the wing structure or are integral with the wing structure, such as heating pads embedded in the leading edge or hot air bleeds from an engine. Failure of a single component in these ice protection systems can be complicated and time consuming to fix.

Furthermore, it is known to provide sailplanes, and the like, with a simple scraper to remove insects and debris from the leading edge of the aerodynamic surface. Scrapers of this kind are operated by pulley systems and require a pilot to manually position, operate, and remove them during flight. Scrapers of this type do not have the ability to deal with ice buildup and are not suitable for use on commercial transport aircraft.

### SUMMARY

According to an embodiment of the invention, there is provided a device for removing debris, such as insects and ice, from an aerodynamic structure of an aircraft, the aerodynamic structure having upper and lower surfaces separated by a leading edge extending along a length of the aerodynamic structure, the device comprising a spine positionable so as to extend between the upper and lower surfaces over the leading edge of the aerodynamic structure, a scraping edge carried by the spine facing a direction that extends along the length, and a drive mechanism configured to move the spine in the direction so that the scraping edge scrapes debris from the aerodynamic structure, wherein the spine is configured to bias the scraping edge against the aerodynamic structure.

The spine is configured to bias the scraping edge against the aerodynamic structure along the length of the spine.

The spine may be flexible and may include an elongate main body and a flange extending from a longitudinal edge of the main body. The scraping edge can then be formed at an end of the flange remote from the main body.

A biasing element may be mounted to the main body to bias the flange, and the scraping edge formed at an end of the flange, in a direction towards the aerodynamic surface on which the spine is positioned.

The main body may comprises a base wall positionable against the aerodynamic structure and a wall extending upwardly from the base in a direction away from the aerodynamic structure to define a recess along the length of the spine, the biasing element being received in the recess.

The flange may extend from the wall and the biasing element is configured to act on the wall to deflect the flange and bias the scraping edge against the aerodynamic surface.

In some embodiments, the wall may be divided into sections by slots in the main body.

A heating element may be received in the flange adjacent to the scraping edge and extends along the length of the spine.

The flange may comprise a plurality of spaced connecting arms extending between the wall and the scraping element. The heating element may be received in a space in the flange beneath the spaced connecting arms.

The flange may extend from opposing longitudinal edges of the main body, each flange having a scraping element that faces in opposite directions extending along the length of the aerodynamic surface, wherein the biasing element is configured to bias each scraping element against the aerodynamic surface.

The biasing element may comprise a plurality of springs spaced from each other along the length of the spine and positioned so as to apply a biasing force to the flange to urge the scraping edge in a direction towards the aerodynamic surface.

The drive mechanism may be positionable within the aerodynamic structure for connection to the spine extending between the upper and lower surfaces and over the leading edge of the aerodynamic structure.

The spine may be formed from heat resistant polycarbonate.

According to another aspect of the invention, there is provided an aerodynamic structure incorporating the device for removing debris according to the invention.

### BRIEF DESCRIPTION OF THE DRAWINGS

Embodiments of the invention will now be described, by way of example only, with reference to the accompanying drawings, in which:

FIG. 1 shows a schematic perspective/front view of a known aircraft;

FIG. 2 shows a schematic cross-sectional view of an aerodynamic structure of the aircraft in FIG. 1;

FIG. 3 shows a schematic perspective view of an embodiment of a device according to the invention for removing debris positioned over a leading edge of the aerodynamic structure shown in FIG. 1 and FIG. 2;

FIG. 4 shows a schematic cross-sectional view of a portion of the device shown in FIG. 3;

FIG. 5 shows a schematic cross-sectional view of the device for removing debris positioned over the leading edge of the aerodynamic structure shown in FIG. 1; and,

FIG. 6 shows a schematic cross-sectional view of another embodiment of the device for removing debris positioned over the leading edge of the aerodynamic structure shown in FIG. 1.

### DETAILED DESCRIPTION

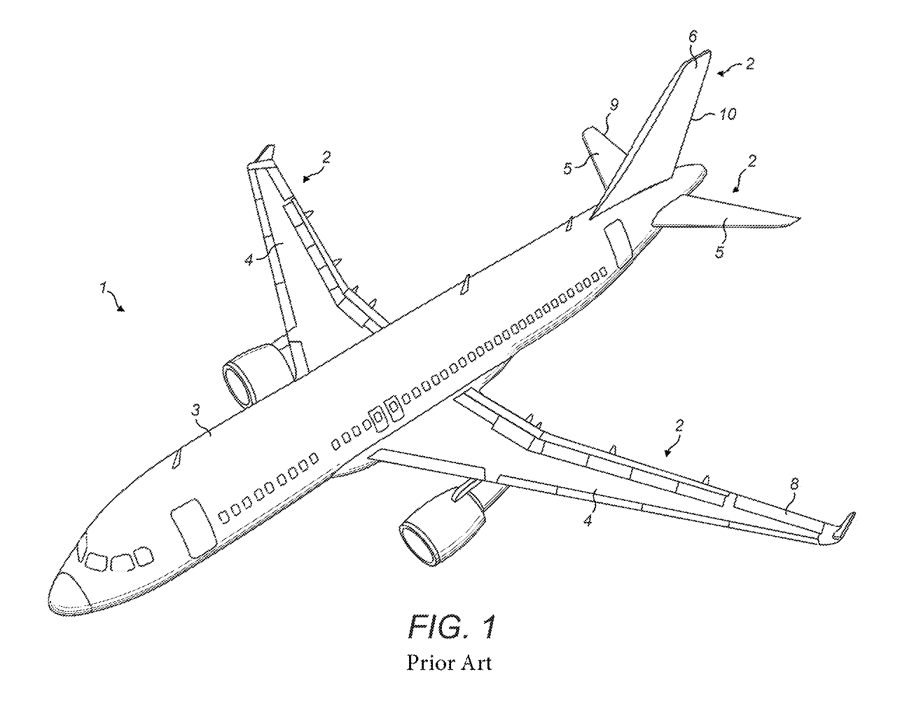

Referring to FIG. 1, a commercial aircraft 1 of known configuration is shown. The aircraft 1 comprises aerodynamic structures 2 that extend from a fuselage 3. The aerodynamic structures include the main wings 4, tailplanes 5 and vertical tail 6.

The main wings 4 provide the majority of the lift. Ailerons 8 on the main wing 4 are used to control the roll of the aircraft 1 about its longitudinal axis. The tailplane 5 also contributes to the lift force. Elevators 9 on the tailplane 5 are used to control the pitch of the aircraft 1 about its lateral axis. The vertical tail 6 comprises a rudder 10 which helps to control the yaw of the aircraft 1 about its vertical axis.

The aerodynamic structures 2 on modern aircraft 1 are tapered in an outboard direction away from the fuselage 3, as shown in FIG. 1. Therefore, the chord of the aerodynamic structure 2 at its root, where the aerodynamic structure 2 joins the fuselage, is greater than at its tip. The thickness of the aerodynamic structures 2 also vary along its span and therefore, the profile, or cross-section, of the aerodynamic structures 2 also vary.

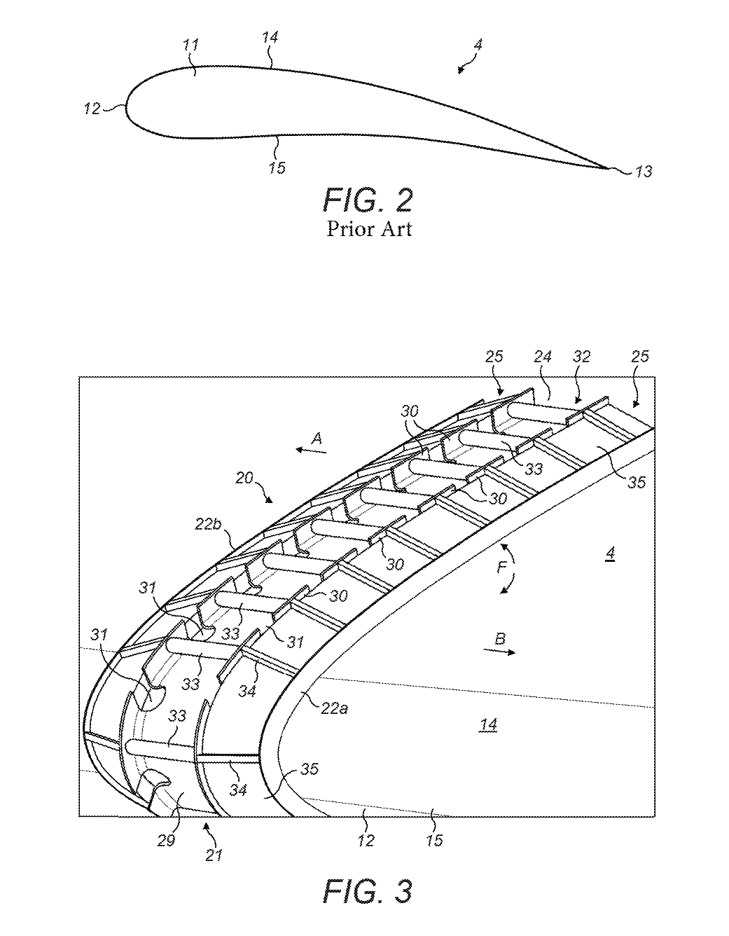

Referring to FIG. 2, a cross-sectional profile through a main wing 4 is shown. The aerodynamic structure 2 comprises a body 11. The body 11 comprises a leading edge 12. The leading edge 12 is the first component of the main wing 4 which the airflow encounters during flight. Therefore, especially during take-off and landing, insects or debris may accumulate on the leading edge 12.

Furthermore, during cruise atmospheric icing can occur on and/or just behind the leading edge 12. This can lead to flow separation from the aerodynamic structure 2 and reduce the ability to control the aircraft 1.

The body 11 of the aerodynamic structure 2 further comprises a trailing edge 13. The trailing edge 13 is the last component of the aerodynamic structure 2 which the airflow encounters during flight and is where the control surfaces, such as the ailerons 8, elevators, 9 and rudder 10, shown in FIG. 1, are located.

The body 11 further comprises an upper surface 14 and a lower surface 15. Both the upper and lower surfaces 14, 15 extend from the leading edge 12 back to the trailing edge 13 and are profiled to generate lift during flight.

Other systems, such as fuel tanks (not shown) and actuators (not shown) for the control surfaces 8, 9, 10 may be disposed internally of the body 11.

Referring now to FIG. 3, a device according to an embodiment of the invention, for removing debris, such as insects and ice, from an aerodynamic structure 2 is shown mounted to a wing 4 of FIG. 2. The device comprises an elongate flexible spine 20 that is positioned on the wing 4 so that it extends between upper and lower surfaces 14, 15 and wraps around its leading edge 12.

The spine 20 carries a scraping edge 22. In the illustrated embodiment, the spine 20 carries two scraping edges 22a, 22b which are supported by the spine 20 and which extend along opposing longitudinal edges. One scraping edge 22b faces in an inboard direction towards the fuselage 3 and, the other scraping edge 22a faces in an outboard direction away from the fuselage 3. In another, unillustrated embodiment, there is only one scraping edge 22 extending along one longitudinal edge of the spine 20.

The spine 20 comprises a main body 24 and a flange 25 on either side of the main body 24 that extends outwardly from each longitudinal edge of the main body 24 for the length of the spine 20. The scraping edge 22a, 22b is formed on or is mounted to, an end of the flange 25 remote from the main body 24. Each flange 25 may flex upwardly and downwardly relative to the main body 24, in the direction indicated by arrow ‘F’ in FIG. 3, in order to enable the scraping edge 22a, 22b to be biased downwardly, towards and against the surface of the wing 4 upon which the spine 20 is positioned.

The spine 20 is mounted to the wing 4 via a coupling 26 (see FIGS. 5 and 6) which allows the spine to slide in a direction along the length of the wing 4 in an inboard or outboard direction (i.e. direction ‘A’ or ‘B’, as shown in FIG. 3), and in response to operation of a drive mechanism 36, such as a motor, mounted within the wing 4. The coupling 26 may take the form of one or more bearings 27 received within a slide member 28 which is of conventional design and will not be described here in detail.

As the spine 20 is driven in an inboard or outboard direction along the length of the aerodynamic structure in the direction of arrows ‘A’ or ‘B’, one of the outboard scraping edges 22a, 22b, which are biased against the surface of the wing 4, removes insects and ice from the surface, depending on the direction of travel of the spine 20. When the spine 20 is driven in an outboard direction ‘B’, scraping edge 22a removes insects and ice from the wing 4, and when the spine 20 is driven in the inboard direction ‘A’, scraping edge 22b removes insects and ice from the surface of the wing 4.

The main body 24 at a center section 21 of the spine 20 comprises a base wall 29 that is placed on the surface of the aerodynamic structure 2. Side walls upstand from opposing edges of the base wall 29 and extend along the length of the main body 24. Slots 31 are formed in the main body 24 to divide the side walls into individual wall sections 30. The base wall 29 and wall sections 30 together define a recess 32 to receive a biasing element 33. The biasing element 33 may comprise a plurality springs or spring-like elements that are parallel to and spaced from each other and have their axis extending at right angles to the longitudinal edge of the spine 20. Each spring 33 may extend between corresponding facing walls or wall sections 30 and they act to bias the walls or wall sections 30 in opposite directions away from each other in inboard and outboard directions extending along the length of the wing 4, i.e. in the directions indicated by arrows ‘A’ and ‘B’ in FIG. 3. The action of the springs of the biasing element 33 against the wall sections 30 causes the wall sections 30 to bow outwardly. As each flange 25 extends from the walls or wall sections 30, they are urged, together with their scraping edges 22a, 22b formed at the remote end of each flange 25, in a downward direction towards and into contact with the aerodynamic surface 2 upon which the spine 20 is positioned . This means that, as the spine 20 is driven in an inboard or outboard direction along the length of the wing 4, the scraping edge 22a, 22b is biased against the wing 4 and effectively scrapes the surface to remove any buildup of ice or bugs.

The scraping edge 22a, 22b may be connected to the wall sections 30 by spaced connecting arms 34. A connecting arm 34 may extend from an upper region of each wall section 30 at a downward angle to a location close to an associated scraping edge 22a, 22b. A space is formed beneath or between the connecting arms 34, which may receive a flexible heating element 35 positioned adjacent to the scraping edge 22a, 22b and to which power may be supplied to heat the scraping edge 22a, 22b and thereby assist in ice removal.

The spine 20 and flange 25 may be integrally formed from, for example, heat resistant polycarbonate.

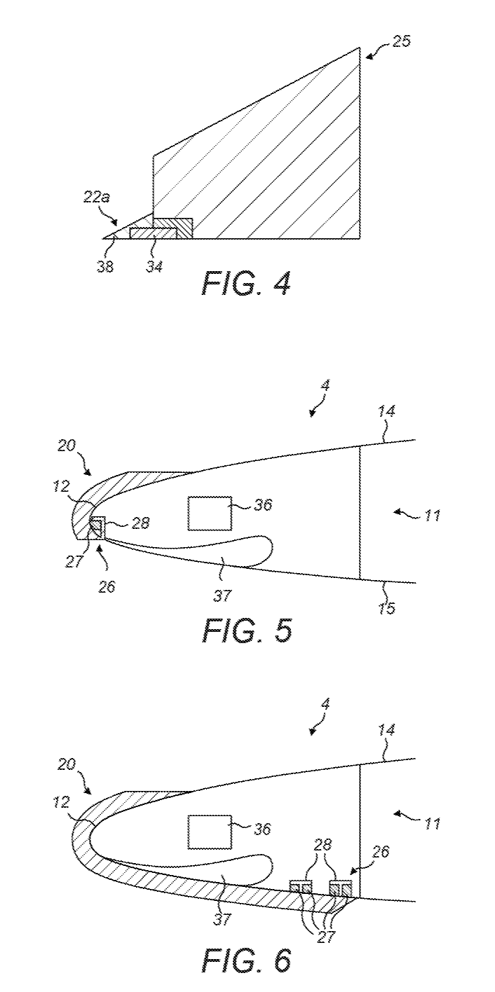

Referring to FIG. 4, a partial cross-section through a flange 25 of the spine 20 of FIG. 3 is shown and from which it is apparent that the scraping edge 22a may take the form of a blade 38. The blade 38 may be formed from a metallic material and can be embedded in the flange 25.

Referring now to FIG. 5 and FIG. 6, schematic cross-sectional views of two different arrangements for mounting the spine 20 to the wing 4 are shown. As described above, the spine 20 is attached to the wing 4 by a coupling 26 that enables the spine 20 to slide in inboard and outboard directions. For example, bearings 27 may be rotatably mounted to the spine 20 and received in a slide member 28 attached to the wing 4. A drive mechanism 36, such as a motor, is located within the wing 4 and is operable to slide the spine 20 along the slide member 28 in each direction.

In the embodiment shown in FIG. 5, the coupling 26 comprises a single slide track 28 situated in front of a kreuger flap 37. In the embodiment shown in FIG. 6, the coupling 26 comprises double tracks 28 located behind the kreuger flap 37. Therefore, operation of the kreuger flap 37 is not prevented due to the presence of the device 20. When the kreuger flap 37 is deployed, operation of the device 20 is reduced to a section of the wing 4 where the kreuger flap 45 is not deployed. Alternatively, the device 20 may return to a “home” position when not in use so that it does not obstruct control surfaces, such as the kreuger flap 37.

It will be appreciated that the spine 20 may be driven from the motor 36 by a pulley. Alternatively, the motor may be external, a drive shaft and screw, or an internal gear may be employed.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

The invention is:

1. A device for removing debris from an aerodynamic structure of an aircraft, wherein the aerodynamic structure includes upper and lower surfaces separated by a leading edge extending along a length of the aerodynamic structure, the device comprising:
a spine positionable so as to extend between the upper and lower surfaces over the leading edge of the aerodynamic structure,
a scraping edge carried by the spine facing a direction that extends along the length, and
a drive mechanism configured to move the spine in the direction so that the scraping edge scrapes debris from along the length of the aerodynamic structure,
wherein the spine is flexible and includes an elongate main body and a flange extending from a longitudinal edge of the main body, the scraping edge being formed at an end of the flange remote from the main body, the device further comprising a biasing element mounted to the main body to bias the scraping edge against the aerodynamic structure.

2. The device according to claim 1, wherein the spine is configured to bias the scraping edge against the aerodynamic structure along the length of the spine.

3. The device according to claim 1, wherein the main body comprises a base wall positionable against the aerodynamic structure and another wall extending upwardly from the base in a direction away from the aerodynamic structure to define a recess along the spine, the biasing element being received in the recess.

4. The device according to claim 3, wherein the flange extends from the another wall and the biasing element is configured to act on the another wall to deflect the flange and bias the scraping edge against the aerodynamic surface.

5. The device according to claim 4, wherein the another wall is divided into sections by slots in the main body.

6. The device according to claim 3, wherein a heating element is received in the flange adjacent to the scraping edge and extends along the spine.

7. The device according to claim 6, wherein the flange comprises a plurality of spaced connecting arms extending between the another wall and the scraping element.

8. The device according to claim 7, wherein the heating element is received in a space in the flange beneath the spaced connecting arms.

9. The device according to claim 3, wherein a flange extends from each of opposing longitudinal edges of the main body and the scraping edge includes scraping elements, each flange including one or more of the scraping elements that faces such that the scraping element on the flange on one of the edges of the main body extends in an opposite direction to the scraping element on the flange extending from the opposite edge of the main body, wherein the biasing element is configured to bias each scraping element against the aerodynamic surface.

10. The device according to claim 3, wherein the biasing element comprises a plurality of springs spaced from each other along the length of the spine and positioned so as to apply a biasing force to the flange to urge the scraping edge in a direction towards the aerodynamic surface.

11. The device according to claim 1, wherein the drive mechanism is positionable within the aerodynamic structure for connection to the spine extending between the upper and lower surfaces and over the leading edge of the aerodynamic structure.

12. The device according to claim 1, wherein the spine is formed from heat resistant polycarbonate.

13. An aerodynamic structure incorporating the device for removing debris according to claim 1.

14. A device configured to be mounted to an aerodynamic structure a leading edge extending a length of a span of the structure and upper and lower surfaces extending reward of the leading edge in a chord direction, the device comprising:
a flexible spine including an elongate main body and a flange extending from a longitudinal edge of the main body, wherein the elongate main body is oriented parallel to a chord of the aerodynamic structure and the main body is configured to seat on and abut the leading edge;
a scraping edge on a longitudinal edge of the flange opposite to an edge of the flange attached to the main body;
a drive mechanism coupled to the flexible spine and to the aerodynamic structure, wherein the drive mechanism is configured to slide the spine along the span of the aerodynamic structure; and
a biasing element mounted to the main body and configured to bias the scraping edge against the aerodynamic structure.

15. The device of claim 14 further comprising a second flange extending from a second longitudinal edge of the main body, and a second scraping edge on a longitudinal edge of the second flange which is opposite to an edge of the second flange adjacent the main body.

16. The device of claim 14 wherein the biasing element is a plurality of biasing elements mounted to the main body of the flexible spine and each applying a biasing force to the flange.

17. A method to remove debris from an aerodynamic structure of an aircraft, the method comprising:
while the aircraft is moving, sliding a flexible spine across a leading edge of the aerodynamic structure, wherein the flexible spine has a length in a direction of a chord of the aerodynamic structure greater than a width in a direction of a span of the aerodynamic structure;
as the flexible spine slides across the leading edge, removing debris on the leading edge with a scraping edge on at least one side of the flexible spine, and
biasing the scraping edge against the leading edge and at least one of an upper or lower surface of the aerodynamic surface while the flexible spine slides across the leading edge.

18. The method of claim 17 wherein the biasing includes biasing an entire length of the scraping edge against the leading edge and the at least one of an upper or lower surface of the aerodynamic surface.

19. The method of claim 17 wherein the flexible spine includes an elongate main body oriented in the direction of the chord and an elongate flange extending from a side of the main body, wherein the scraping edge is on an edge of the elongate flange opposite to an edge of the flange adjacent the main body, and the biasing of the scraping edge includes biasing the flange by a biasing element mounted to the main body.
